(19) United States
(12) Patent Application Publication
(10) Pub. No.: US 2019/0158638 A1
(43) Pub. Date: May 23, 2019

(54) TRANSMISSION DEVICE AND TRANSMISSION METHOD

(71) Applicant: FUJITSU LIMITED, Kawasaki-shi (JP)

(72) Inventors: Koji YANAI, Machida (JP); Hideki KANGYU, Fuchu (JP); Norio SAKAI, Edogawa (JP)

(73) Assignee: FUJITSU LIMITED, Kawasaki-shi (JP)

(21) Appl. No.: 16/191,496

(22) Filed: Nov. 15, 2018

(30) Foreign Application Priority Data
Nov. 17, 2017 (JP) 2017-221761

(51) Int. Cl. H04L 29/08

(52) U.S. Cl. CPC H04L 69/325; H04L 69/324

(57) ABSTRACT

A transmission device includes a plurality of ports, a first conversion circuit that converts a frame that is input to any one of the plurality of ports and does not include a destination address of a network layer into a packet including the destination address of the network layer, a specification circuit that specifies a port corresponding to the destination address of the network layer of the packet that is converted by the first conversion circuit among the plurality of ports, a second conversion circuit that converts the packet into the frame that does not include the destination address of the network layer, and an output control circuit that causes the frame that is converted by the second conversion circuit to be output from the port that is specified by the specification circuit.

### CROSS-REFERENCE TO RELATED APPLICATION

This application is based upon and claims the benefit of priority of the prior Japanese Patent Application No. 2017-221761, filed on Nov. 17, 2017, the entire contents of which are incorporated herein by reference.

### FIELD

The embodiment discussed herein is related to a transmission device and a transmission method.

### BACKGROUND

Ethernet OAM CFM is used for an operation, a management, and maintenance of a network of a data link layer. OAM is an abbreviation for operation, administration, maintenance, and CFM is abbreviation for connectivity fault management. Ethernet is a registered trademark. Ethernet OAM is standardized by IEEE 802.3, ITU-T Y. 1731, and the like. In the Ethernet OAM, for example, a frame for inspection called an “OAM frame” is used to perform communication confirmation in the data link layer. IEEE is an abbreviation for the Institute of Electrical and Electronics Engineers. ITU-T is an abbreviation for International Telecommunication Union-Telecommunication sector (International Telegraph and Telephone Consultative Committee).

In the related art, there is a network connection device including a switching unit that operates as an edge/switch of a layer 2 network which forms a first virtual link and a routing unit that operates as an edge/router of a layer 3 network which forms a second virtual link. The network connection device further includes a conversion unit that mutually converts a frame of the layer 2 network and a packet of the layer 3 network.

However, a technique in the related art has a problem in which, in a case where a transmission device that performs processing of a network layer is installed between apparatuses that perform processing of a data link layer, the transmission device may not transmit a frame input from an apparatus that performs processing of one data link layer to an apparatus that performs processing of the other data link layer.

The following is a reference document. [Document 1] International Publication Pamphlet No. WO 2009/051179.

### SUMMARY

According to an aspect of the embodiments, a transmission device includes a plurality of ports, a first conversion circuit that converts a frame that is input to any one of the plurality of ports and does not include a destination address of a network layer into a packet including the destination address of the network layer, a specification circuit that specifies a port corresponding to the destination address of the network layer of the packet that is converted by the first conversion circuit among the plurality of ports, a second conversion circuit that converts the packet into the frame that does not include the destination address of the network layer, and an output control circuit that causes the frame that is converted by the second conversion circuit to be output from the port that is specified by the specification circuit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a transmission device according to an embodiment;

FIG. 2 is a diagram illustrating an example of processing performed by the transmission device according to the embodiment;

FIG. 3 is a diagram illustrating an example of a carrier network according to the embodiment;

FIG. 4 is a diagram illustrating an example of a hardware configuration of the transmission device according to the embodiment;

FIG. 5 is a diagram illustrating an example of a conversion table according to the embodiment;

FIG. 6 is a diagram illustrating an example of a distribution table according to the embodiment;

FIG. 7 is a diagram (part 1) illustrating an example of an operation of the transmission device according to the embodiment;

FIG. 8 is a diagram (part 2) illustrating an example of the operation of the transmission device according to the embodiment;

FIG. 9 is a diagram (part 3) illustrating an example of the operation of the transmission device according to the embodiment;

FIG. 10 is a diagram (part 4) illustrating an example of the operation of the transmission device according to the embodiment;

FIG. 11 is a diagram (part 5) illustrating an example of the operation of the transmission device according to the embodiment;

FIG. 12 is a diagram (part 6) illustrating an example of the operation of the transmission device according to the embodiment;

FIG. 13 is a diagram (part 7) illustrating an example of the operation of the transmission device according to the embodiment;

FIG. 14 is a flowchart illustrating an example of registration processing performed by the transmission device according to the embodiment;

FIGS. 15A and 15B are flowchart (part 1) illustrating an example of transmission processing performed by the transmission device according to the embodiment;

FIG. 16 is a flowchart (part 2) illustrating an example of the transmission processing performed by the transmission device according to the embodiment; and

FIG. 17 is a diagram illustrating an example of transmission of an OAM frame in a carrier network in which the transmission device according to the embodiment is installed.

### DESCRIPTION OF EMBODIMENTS

Hereinafter, embodiments of a transmission device and a transmission method according to the embodiment will be described in detail below with reference to the drawings.

Example of Transmission Device According to Embodiment

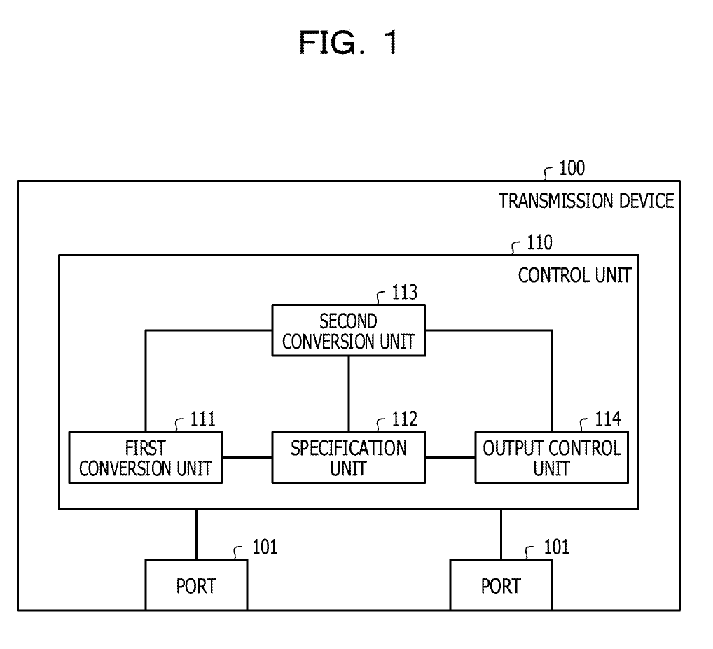

FIG. 1 is a diagram illustrating an example of a transmission device according to an embodiment. The transmission device 100 according to the embodiment illustrated in FIG. 1 includes a plurality of ports 101. As a frame not including the destination address of the network layer is input to any port 101, the transmission device 100 transmits a frame not including a destination address of a network layer. The frame is data of, for example, a data link layer protocol (for example, layer 2).

As a packet including a destination address of a network layer is input to any port 101, the transmission device 100 may transmit an input packet based on a destination address of the input packet. For example, as a packet is input to any port 101, the transmission device 100 may be a layer 3 switch (router) that transmits an input packet based on a destination address of the input packet. The packet is data of, for example, a network layer protocol (for example, layer 3).

The transmission device 100 is connected to, for example, an apparatus that performs processing of a data link layer, or an apparatus that performs processing of a network layer. The apparatus that performs the processing of the data link layer is, for example, a layer 2 switch or a media converter. Hereinafter, the layer 2 switch may be referred to as “L2SW”, and the media converter may be referred to as “MC”. The apparatus that performs the processing of the network layer is, for example, a layer 3 switch (including the transmission device 100, for example).

A frame not including the destination address of the network layer is input to the port 101. The frame not including the destination address of the network layer is, for example, a frame having no destination IP address corresponding to the destination address of the network layer. For example, the frame not including the destination address of the network layer may be a frame having no IP header. The IP header is a header in which the destination IP address and the like are stored. IP is an abbreviation for Internet Protocol.

An example of the frame not including the destination address of the network layer is a frame for inspection made by the Ethernet OAM. Hereinafter, the frame for inspection made by the Ethernet OAM may be referred to as an “OAM frame”. For example, the OAM frame is a frame for implementing CC, LB, LT, and the like prepared as a function performed by the Ethernet OAM. CC is an abbreviation for Continuity Check, LB is an abbreviation for Loop Back, and LT is an abbreviation for Link Trace.

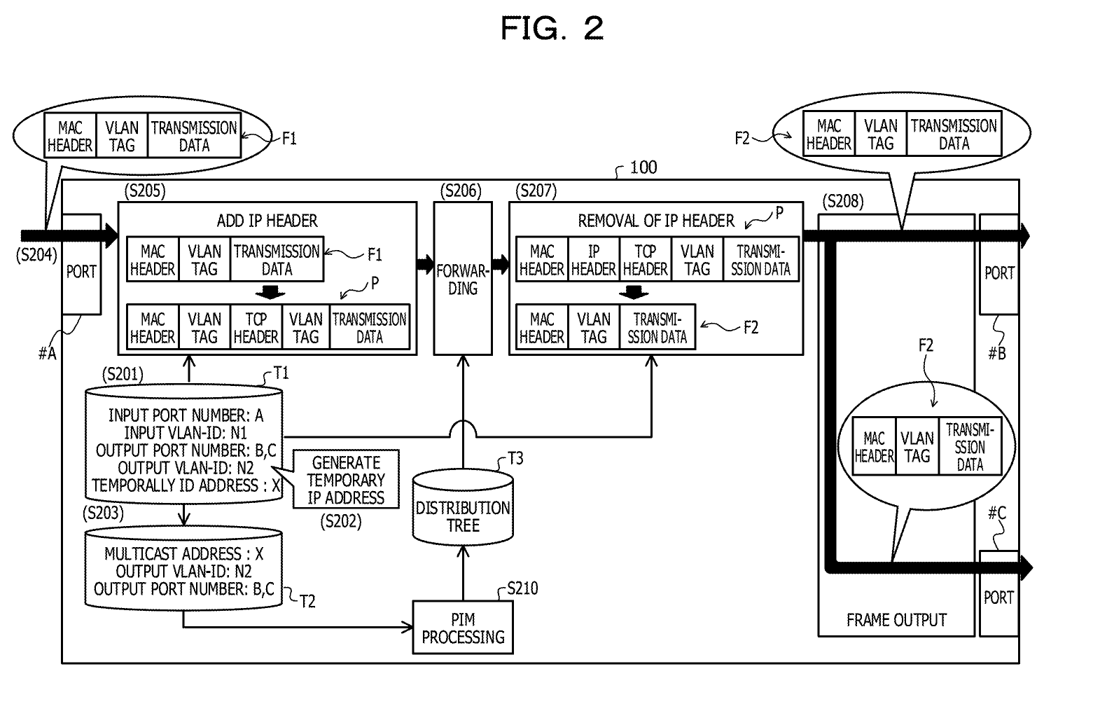

The Ethernet OAM is standardized by IEEE802.3 and the like as described above. A multicast frame having no destination IP address (for example, having no IP header) is widely used As the OAM frame, as will be described below using FIG. 2 and the like.

The port 101 to which the frame not including the destination address of the network layer is input inputs the input frame to a control unit 110 of the transmission device 100. A packet including the destination address of the network layer may be input to the port 101. In this case, for example, the port 101 to which the packet including the destination address of the network layer is input inputs the input packet to the control unit 110. The port 101 is, for example, a physical port installed in the transmission device 100.

The control unit 110 includes a first conversion unit 111, a specification unit 112, a second conversion unit 113, and an output control unit 114. The first conversion unit 111 converts the frame not including the destination address of the network layer input to the control unit 110 into a packet including the destination address of the network layer.

For example, the first conversion unit 111 converts the input frame into a packet by adding a header storing the destination address of the network layer to the input frame. The header storing the destination address of the network layer is, for example, an IP header. The first conversion unit 111 may convert the input frame into a packet by adding an IP header to the input frame.

Thereby, the first conversion unit 111 may convert the input frame into a packet without changing portions other than the header to be added. Thus, even if the input frame is converted into a packet, the first conversion unit 111 may maintain the content of the input frame with respect to the portions other than the header to be added. The first conversion unit 111 may convert the input frame into a packet through simple processing of adding a header in which the destination address of the network layer is stored

In a case where the input frame is a specific type frame, the first conversion unit 111 may convert the input specific type frame into a packet. In this case, the first conversion unit 111 may not convert the input frame into a packet in a case where the input frame is a frame of a type other than the specific type.

Thereby, the first conversion unit 111 may transmit only the specific type frame among the input frames to the transmission device 100. Thus, the first conversion unit 111 may reduce a processing load of the transmission device 100, as compared with a case where frames other than the specific type among the input frames are also transmitted to the transmission device 100. The first conversion unit 111 may reduce traffic of a transmission destination network made by the transmission device 100, as compared with a case where frames other than the specific type among the input frames are also transmitted to the transmission device 100.

The specific type frame may be, for example, an OAM frame. Thereby, the first conversion unit 111 may transmit only the OAM frame desirable for using a function performed by the Ethernet OAM among the input frames to the transmission device 100.

The first conversion unit 111 may receive information indicating a port 101 to which a frame not including the destination address of the network layer is input and the port 101 that outputs a frame not including the destination address of the network layer.

Hereinafter, information indicating the port 101 to which the frame not including the destination address of the network layer is input and the port 101 that outputs the frame not including the destination address of the network layer may be referred to as “input/output port information”. Hereinafter, the port 101 to which the frame not including the destination address of the network layer is input may be referred to as an “input port”. Hereinafter, the port 101 that outputs the frame not including the destination address of the network layer may be referred to as an “output port”.

In a case where the input/output port information is received, for example, as the input/output port information is received, the first conversion unit 111 generates a destination address of a predetermined network layer. For example, as the input/output port information is received at the frame input to the input port indicated by the input/output port information, the first conversion unit 111 converts the input frame into a packet by adding the destination address of the network layer generated.

Thereby, the first conversion unit 111 may generate a destination address of a network layer desirable for specifying the port 101 using the specification unit 112, and add the generated destination address of the network layer to the input frame, thereby being able to convert into a packet.

Thereby, it is possible for the first conversion unit 111 to generate the destination address of the network layer that may be added when receiving the input/output port information. Thus, the first conversion unit 111 may shorten processing time when the input frame is converted into a packet.

The first conversion unit 111 outputs the converted packet to the specification unit 112 and the second conversion unit 113. The first conversion unit 111 may also output information obtained by associating the received input/output port information with the destination address of the network layer generated according to receiving the input/output port information, to the specification unit 112.

Hereinafter, the information obtained by associating the received input/output port information with the destination address of the network layer generated according to receiving the input/output port information may be referred to as “correspondence information”. By causing the first conversion unit 111 to output the correspondence information to the specification unit 112, the specification unit 112 may specify the port 101, based on the correspondence information output from the first conversion unit 111.

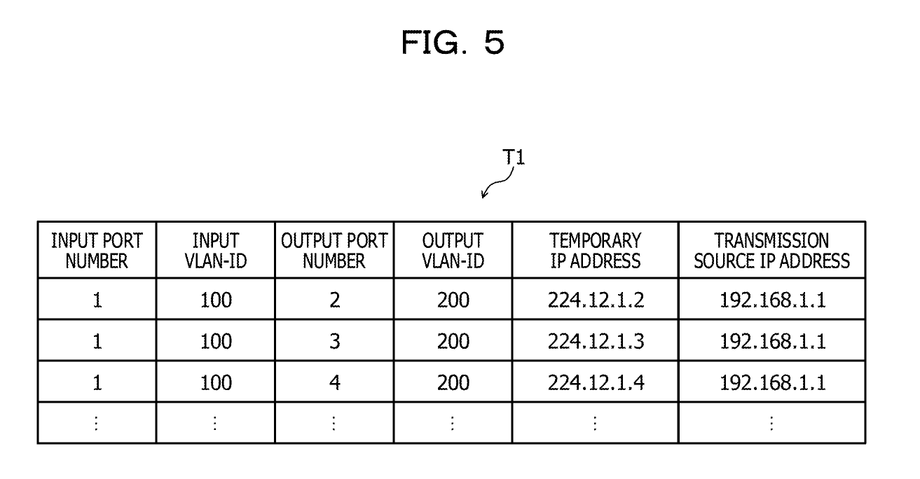

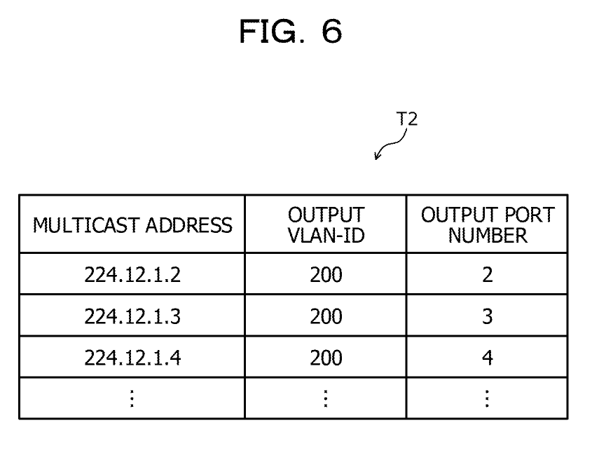

An example of the correspondence information is information stored in, for example, a distribution table which will be described below. The distribution table will be described below with reference to FIG. 2, FIG. 6, and the like. The correspondence information may be, for example, information stored in a conversion table which will be described below. The conversion table will be described below with reference to FIG. 2, FIG. 5, and the like.

In the example described here, the first conversion unit 111 receives the input/output port information, but the example is not limited to this. For example, a reception unit that receives the input/output port information may be installed in the control unit 110 separately from the first conversion unit 111. In the example described here, the destination address of the network layer is generated according to the input/output port information received by the first conversion unit 111, but the example is not limited to this. For example, a generation unit that generates the destination address of the network layer, according to the received input/output port information may be installed in the control unit 110 separately from the first conversion unit 111.

The specification unit 112 specifies the port 101 corresponding to the destination address of the network layer of the packet output from the first conversion unit 111 among a plurality of ports 101, based on the destination address of the network layer of the packet output from the first conversion unit 111. For example, the specification unit 112 specifies the port 101 corresponding to the destination address of the network layer of the packet output from the first conversion unit 111 with reference to the correspondence information output from the first conversion unit 111.

In a case where the port 101 is specified with reference to the correspondence information output from the first conversion unit 111, for example, the specification unit 112 first refers to the destination address of the network layer of the packet output from the first conversion unit 111. Next, the specification unit 112 searches the correspondence information having the same destination address as the destination address obtained by referring to the destination address, from the correspondence information output from the first conversion unit 111. The specification unit 112 specifies the output port indicated by the searched correspondence information as the port 101 corresponding to the packet output from the first conversion unit 111.

In a case where a packet including the destination address of the network layer is input to the control unit 110, the specification unit 112 may specify the port 101 corresponding to the destination address of the network layer of the input packet. In such a case, for example, the specification unit 112 specifies the port 101 corresponding to the destination address of the network layer of the input packet with reference to the information associating any port 101 for each destination address of the network layer. In this case, the information referred to by the specification unit 112 is, for example, information stored in a routing table. In this case, the information referred to by the specification unit 112 may be information stored in, for example, the distribution table or the like.

The specification unit 112 outputs information indicating the specified port 101 to the output control unit 114. The specification unit 112 may further output information indicating the specified port 101 to the second conversion unit 113.

The second conversion unit 113 converts the packet output from the first conversion unit 111 into a frame not including the destination address of the network layer. For example, the second conversion unit 113 removes the header added by the first conversion unit 111 from the packet output from the first conversion unit 111, thereby, converting the packet output from the first conversion unit 111 into a frame not including the destination address of the network layer.

As described above, for example, the packet output from the first conversion unit 111 is obtained by adding a predetermined header to the input frame by the first conversion unit 111. Thus, the second conversion unit 113 converts the packet output from the first conversion unit 111 into the frame having the same content as the input frame by removing the header added by the first conversion unit 111.

Accordingly, for example, in a case where the input frame is the OAM frame, the second conversion unit 113 may convert the input frame into the OAM frame for performing a function of the Ethernet OAM which is the same as the input OAM frame. Thus, the second conversion unit 113 may transmit the OAM frame for performing the function of the Ethernet OAM which is the same as the input OAM frame to the transmission device 100. The second conversion unit 113 may convert the packet output from the first conversion unit 111 into a frame through simple processing of removing a header added by the first conversion unit 111.

The second conversion unit 113 may convert the packet output from the first conversion unit 111 into a frame not including the destination address of the network layer including identification information for identifying the VLAN corresponding to a port specified by the specification unit 112. Hereinafter, the identification information for identifying the VLAN may be referred to as a “VLAN-ID”. In this case, for example, the second conversion unit 113 receives information indicating the specified port 101 output from the specification unit 112. For example, the second conversion unit 113 specifies the VLAN-ID corresponding to the port specified by the specification unit 112 with reference to the information associated with the VLAN-ID corresponding to each port 101. The second conversion unit 113 converts the packet into a frame to which a VLAN tag storing the specified VLAN-ID is added. VLAN is an abbreviation for Virtual LAN, and LAN is an abbreviation for Local Area Network.

The second conversion unit 113 outputs the converted frame to the output control unit 114.

The output control unit 114 causes the frame output from the second conversion unit 113 to be output from the port 101 indicated by the information output from the specification unit 112. Thereby, the transmission device 100 may output the frame converted by the second conversion unit 113 from the port 101 specified by the specification unit 112. Thus, the transmission device 100 may transmit a frame not including a destination of the network layer as a frame not including the destination of the network layer is input to any port 101 of the transmission device 100.

In a case where a packet including the destination address of the network layer is input to the control unit 110, the output control unit 114 may cause the input packet to be output from the port 101 specified by the specification unit 112 for the packet. Thereby, the transmission device 100 may output the input packet specified by the specification unit 112 from the port 101. Thus, the transmission device 100 may transmit the packet input to any port 101 of the transmission device 100, based on the destination address of the network layer of the packet.

Example of Processing Performed by Transmission Device According to Embodiment

FIG. 2 is a diagram illustrating an example of processing performed by the transmission device according to the embodiment. FIG. 2 illustrates an example of processing performed by the transmission device 100 as an OAM frame is input to a port #A of the transmission device 100, in a case where an OAM frame is output from a port #B and a port #C of the transmission device 100. In FIG. 2, the same portions as those in FIG. 1 are denoted by the same reference numerals or symbols, and description thereof will be omitted. In FIG. 2, a case where a frame not including a destination of a network layer input to the transmission device 100 is the OAM frame will be described.

The ports #A to #C illustrated in FIG. 2 are, for example, one of a plurality of the ports 101 illustrated in FIG. 1, and are different ports 101 from each other.

(Step S201) The transmission device 100 registers an input port number and an output port number in a conversion table T1 installed in the transmission device 100 in association with each other. For example, as a registration request indicating an input port number and an output port number designated by an operator is received, the transmission device 100 associates the input port number and the output port number indicated by the received registration request with each other to register in the conversion table T1. The operator is, for example, an administrator of a network in which the transmission device 100 is installed. The registration request is an example of the above-described input/output port information.

In a case of the example illustrated in FIG. 2, the transmission device 100 registers “A” indicating the port #A in the conversion table T1 as an input port number. In the case of the example illustrated in FIG. 2, the transmission device 100 registers “B” indicating the port #B and “C” indicating the port #C in the conversion table T1 as the output port number.

In a case where the input port number is registered in the conversion table T1, the transmission device 100 may also register an input VLAN-ID indicating the VLAN-ID corresponding to a port of the input port number to be registered in the conversion table T1. Likewise, in a case where the output port number is registered in the conversion table T1, the transmission device 100 may also register an output VLAN-ID indicating the VLAN-ID corresponding to a port of the output port number to be registered in the conversion table T1. For example, the above-described registration request includes information indicating an input VLAN-ID and the output VLAN-ID specified by the operator. The transmission device 100 registers the input VLAN-ID and the output VLAN-ID indicated by the received registration request in the conversion table T1.

The transmission device 100 may specify the input VLAN-ID from the input port number indicated by the registration request with reference to the information indicating the VLAN-ID corresponding to each of the ports #A to #C previously stored, and may register the specified input VLAN-ID. Likewise, the transmission device 100 may specify the output VLAN-ID from the output port number indicated by the registration request with reference to the information indicating the VLAN-ID corresponding to each of the ports #A to #C previously stored, and may register the specified output VLAN-ID.

In a case of the example illustrated in FIG. 2, the transmission device 100 registers a VLAN-ID “N1” in the conversion table T1 as an input VLAN-ID. The transmission device 100 registers a VLAN-ID “N2” in the conversion table T1 as an output VLAN-ID. Thereby, for example, even in a case where the VLAN-ID corresponding to the port #A and the VLAN-ID corresponding to the port #B or the port #C are different from each other, the transmission device 100 may transmit a frame input to the port #A from the port #B or the port #C.

(Step S202) If the input port number and the like are registered in the conversion table T1, the transmission device 100 generates an IP address according to a predetermined generation rule. The transmission device 100 registers the generated IP address in the conversion table T1 in association with the input port number and the like registered in step S201. Hereinafter, the IP address generated by the transmission device 100 may be referred to as a “temporary IP address”.

The transmission device 100 generates, for example, a multicast address as the temporary IP address. An example of a generation rule of the temporary IP address will be described below. In a case of the example illustrated in FIG. 2, since the transmission device 100 sets the temporary IP address indicating an IP address “X”, X” is registered in the conversion table T1 as the temporary IP address. The transmission device 100 may generate the temporary IP address for each combination of each input port number and each output port number.

(Step S203) The transmission device 100 registers the output port number registered in step S201 and the temporary IP address registered in step S202 in the distribution table T2 installed in the transmission device 100. For example, the transmission device 100 registers the temporary IP address registered in step S202 in the distribution table T2 as a multicast address indicating a destination of a multicast packet. The transmission device 100 also registers the output port number registered in step S201 in the distribution table T2 in association with the registered multicast address (for example, the temporary IP address).

In a case where the output VLAN-ID is registered in step S201, the transmission device 100 also registers the output VLAN-ID registered in step S201 in the distribution table T2 in association with the registered multicast address.

In a case of the example illustrated in FIG. 2, the transmission device 100 registers the IP address “X” in the distribution table T2 as the multicast address. In the case of the example illustrated in FIG. 2, the transmission device 100 registers the VLAN-ID “N2” in the distribution table T2 as an output VLAN-ID. In the case of the example illustrated in FIG. 2, the transmission device 100 registers “B” indicating the port #B and “C” indicating the port #C in the distribution table T2 as the output port numbers.

For example, the transmission device 100 performs PIM processing (step S210) as illustrated in FIG. 2. In the PIM processing of step S210, the transmission device 100 performs multicast routing by using a PIM of a multicast routing protocol or, an IGMP of a multicast group management protocol, and the like. The PIM is an abbreviation for Protocol-Independent Multicast. The IGMP is an abbreviation for Internet Group Management Protocol.

For example, the transmission device 100 reflects the information registered in the distribution table T2 in step S 203 to a distribution tree T3 by the PIM processing performed for registration in the distribution table T2 in step S 203. In the case of the example illustrated in FIG. 2, the transmission device 100 registers the IP address “X” in the distribution tree T3 as a multicast address. In the case of the example illustrated in FIG. 2, the transmission device 100 registers the VLAN-ID “N2” in the distribution tree T3 as an output VLAN-ID. In the case of the example illustrated in FIG. 2, the transmission device 100 registers “B” indicating the port #B and “C” indicating the port #C in the distribution tree T3 as the output port number.

Thereby, for example, the same content as in the case of receiving the multicast distribution request of the multicast IP address “X” connected to the port #B and the port #C is registered in the distribution tree T3. Thus, by adding the IP header in which the IP address “X” is set as the destination IP address to the input frame as will be described below, the transmission device 100 may perform the same forwarding (routing) as in this case.

(Step S204) Thereafter, it is assumed that an OAM frame F1 is input to the port #A. In this case, the transmission device 100 receives an input of the OAM frame F1. As illustrated in FIG. 2, for example, the OAM frame F1 includes a data structure in which a MAC header is added before transmission data (payload). For example, a destination MAC address corresponding to the destination address of a data link layer is stored in the MAC header. The MAC is an abbreviation for Media Access Control.

As illustrated in FIG. 2, for example, the OAM frame F1 may have a data structure in which a VLAN tag is further added between the MAC header and the transmission data. For example, the VLAN-ID corresponding to the port #A is stored in the VLAN tag of the OAM frame F1.

(Step S205) If the OAM frame F1 is input to the port #A, the transmission device 100 converts the input OAM frame F1 into a multicast packet P. For example, as illustrated in FIG. 2, the transmission device 100 converts the OAM frame F1 into the multicast packet P by adding the IP header to the input OAM frame F1.

For example, the transmission device 100 specifies the temporary IP address “X” associated with the port (for example, port #A) to which the OAM frame F1 is input with reference to the conversion table T1. The transmission device 100 adds the IP header in which the specified temporary IP address “X” is set as the destination IP address to the OAM frame F1. The transmission device 100 may add the IP header in which the preset IP address is set to a port (for example, the port #A) to which the OAM frame F1 is input set as a transmission source IP address, to the OAM frame F1.

As illustrated in FIG. 2, the transmission device 100 may also add a TCP header at the time of being converted to the multicast packet P. For example, a destination port number, a source port number, and the like are stored in the TCP header. In this case, the transmission device 100 may add the TCP header of any content. TCP is abbreviation for Transmission Control Protocol.

(Step S206) If the OAM frame F1 is converted into the multicast packet P, the transmission device 100 performs forwarding (routing) of the converted multicast packet P. For example, the transmission device 100 specifies a port associated with the destination IP address “X” (for example, the temporary IP address) indicated by the IP header of the multicast packet P with reference to the distribution tree T3. In the case of the example illustrated in FIG. 2, the port #B and the port #C are specified thereby. The transmission device 100 may specify the port associated with the destination IP address (for example, the temporary IP address) indicated by the IP header of the multicast packet P with reference to the distribution table T2.

(Step S207) After the forwarding, the transmission device 100 converts the multicast packet P into the OAM frame F2. For example, as illustrated in FIG. 2, the transmission device 100 converts the multicast packet P into an OAM frame F2 by removing the IP header added in step S205 from the multicast packet P. In a case where the TCP header is also added when being converted into the multicast packet P, the transmission device 100 also removes the added TCP header at this time.

At this time, the transmission device 100 may convert the multicast packet P into the OAM frame F2 to which a new VLAN tag is added with reference to the conversion table T1. In the case of the example illustrated in FIG. 2, for example, the transmission device 100 adds a VLAN tag indicating a VLAN-ID “N2” corresponding to the port #B and the port #C to which the OAM frame F2 is output.

(Step S208) The transmission device 100 outputs the OAM frame F2 obtained by conversion in step S207 from the port specified in step S206. Thereby, in the case of the example illustrated in FIG. 2, the OAM frame F2 is output from the port #B and the port #C. For example, the transmission device 100 may output the OAM frame F2 from the port #B and the port #C as the OAM frame F1 is input to the port #A. Thus, the transmission device 100 may transmit a frame not including an input destination of a network layer to a network of the network layer as a frame, not as a packet.

For example, the processing of steps S201 to S203 and step S205 illustrated in FIG. 2 is an example of the processing of the first conversion unit 111 illustrated in FIG. 1. For example, the processing of step S206 and step S210 illustrated in FIG. 2 is an example of the processing of the specification unit 112 illustrated in FIG. 1. For example, the processing of step S207 illustrated in FIG. 2 is an example of the processing of the second conversion unit 113 illustrated in FIG. 1. For example, the processing of step S 208 illustrated in FIG. 2 is an example of the processing of the output control unit 114 illustrated in FIG. 1.

Next, an example of a carrier network installed in the transmission device 100 will be described.

Example of Carrier Network According to Embodiment

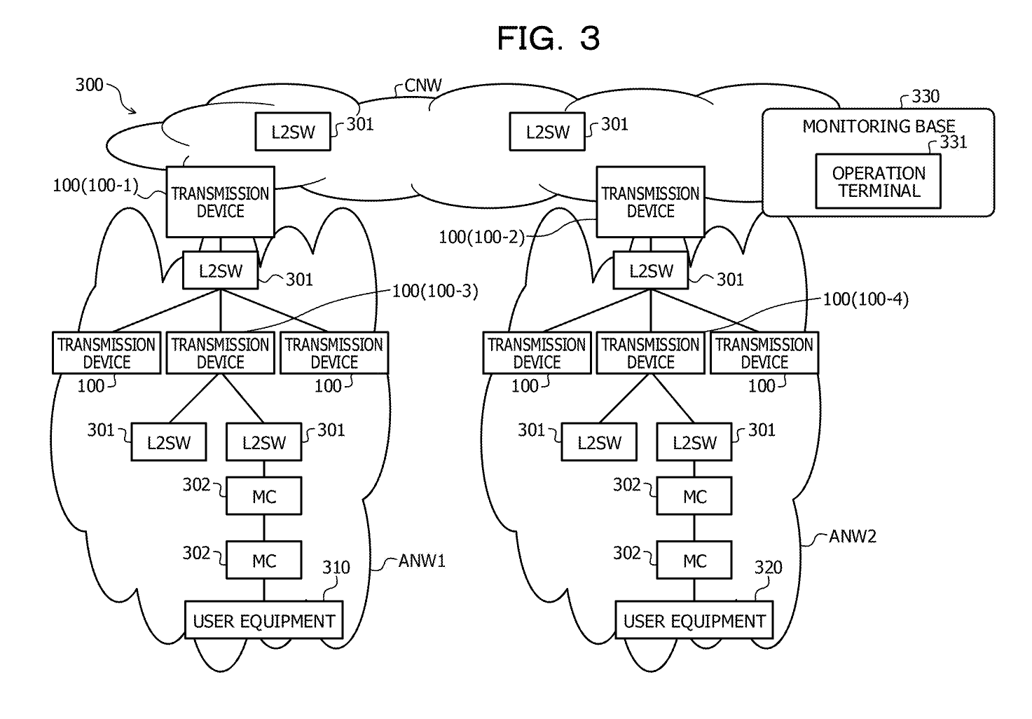

FIG. 3 is a diagram illustrating an example of the carrier network according to the embodiment. In FIG. 3, the same portions as those in FIG. 1 are denoted by the same reference numerals or symbols, and description thereof will be omitted. The carrier network 300 according to the embodiment illustrated in FIG. 3 includes a core network CNW, an access network ANW1, and an access network ANW2.

The core network CNW is, for example, a backbone network that bundles a plurality of access networks including the access network ANW1 and the access network ANW2 and performs high-capacity transmission. The access network ANW1 and the access network ANW2 are, for example, networks forming an access line from the core network CNW to the user source (for example, user equipment 310 and 320 which will be described below).

In the respective networks CNW, ANW1, and ANW2, for example, the transmission devices 100, L2SW 301, MC 302, and the like are installed as illustrated in FIG. 3. For example, in the example illustrated in FIG. 3, the transmission device 100 is installed to connect the core network CNW to the access network ANW1. Hereinafter, the transmission device 100 installed to connect the core network CNW to the access network ANW1 may be referred to as a “transmission device 100-1”.

For example, in the example illustrated in FIG. 3, the transmission device 100 is installed to connect the core network CNW to the access network ANW2. Hereinafter, the transmission device 100 installed to connect the core network CNW to the access network ANW2 may be referred to as a “transmission device 100-2”. For example, the transmission device 100-1 and the transmission device 100-2 are connected to each other via the L2SW 301 installed in the core network CNW.

The transmission device 100 may be installed between apparatuses installed in the access network ANW1 as illustrated in the transmission device 100 denoted by a reference numeral 100-3 in FIG. 3. Likewise, the transmission device 100 may be installed between apparatuses installed in the access network ANW2 as illustrated in the transmission device 100 denoted by a reference numeral 100-4 in FIG. 3.

The user equipment 310 (for example, a router) of a user who is provided with a layer 2VPN service is installed in the access network ANW1. The user equipment 320 is installed in the access network ANW2. The user equipment 320 is, for example, the equipment of a layer 2VPN service provider that provides the layer 2VPN built on the carrier network 300. For example, in the example illustrated in FIG. 3, the layer 2VPN service provider provides a user of a terminal (for example, a PC) (not illustrated) connected to the user equipment 310 and the user equipment 320 with the layer 2VPN built on the carrier network 300. VPN is an abbreviation for Virtual Private Network. PC is an abbreviation for Personal Computer.

As illustrated in FIG. 3, an operation terminal 331 used by an operator of the layer 2VPN service provider is installed in a monitoring base 330 of the layer 2VPN service provider. For example, the operation terminal 331 is connected to the carrier network 300 in a state where the operation terminal may communicate with the transmission device 100 installed in the carrier network 300. The operation terminal 331 is, for example, a PC.

In the example illustrated in FIG. 3, the operator of the layer 2VPN service provider performs a predetermined operation input to the operation terminal 331, and thereby, the above-described registration request and the like may be transmitted to the transmission device 100.

Example of Hardware Configuration of Transmission Device According to Embodiment

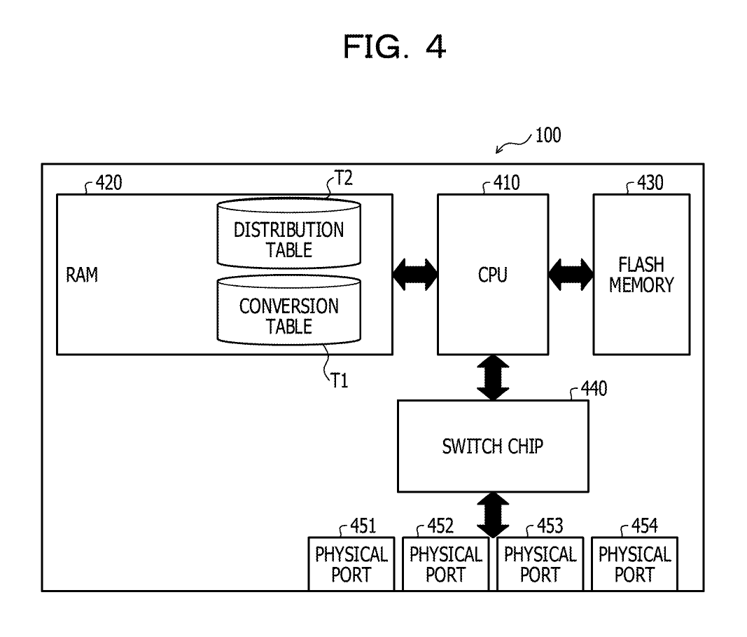

FIG. 4 is a diagram illustrating an example of a hardware configuration of the transmission device according to the embodiment. As illustrated in FIG. 4, the transmission device 100 includes, for example, a CPU 410, a RAM 420, a flash memory 430, a switch chip 440, and physical ports 451 to 454. The respective configuration units are respectively connected by, for example, a bus or the like as illustrated in FIG. 4. CPU is an abbreviation for Central Processing Unit. RAM is an abbreviation for Random Access Memory.

The CPU 410 controls the entire transmission device 100. The RAM 420 and the flash memory 430 store a program and data relating to processing performed by the CPU 410. The RAM 420 is used as a work area of the CPU 410. For example, the CPU 410 loads the program and data stored in the RAM 420 and the flash memory 430 into the RAM 420 and performs processing of coding using the program loaded in the RAM 420.

For example, the data stored in the RAM 420 and the flash memory 430 may include the conversion table T1, the distribution table T2, and the like. Although not illustrated in FIG. 4, the RAM 420 and the flash memory 430 may store a routing table, a MAC learning table, and the like.

The switch chip 440 inputs data input to the physical ports 451 to 454 to the CPU 410. The switch chip 440 outputs data output from the CPU 410 to other apparatuses connected to the transmission device 100 via the physical ports 451 to 454.

In addition to the respective configuration units described above, the transmission device 100 may include an input device (for example, an operation button) for directly inputting various instructions and the like to the transmission device 100, a display device (for example, a display) for displaying various types of information relating to the transmission device 100, and the like.

The processing of the first conversion unit 111 illustrated in FIG. 1 may be realized by, for example, the CPU 410 executing a program stored in the RAM 420 or the flash memory 430 illustrated in FIG. 4. The processing of the specification unit 112 illustrated in FIG. 1 may be realized by, for example, the CPU 410 executing the program stored in the RAM 420 or the flash memory 430 illustrated in FIG. 4.

The processing of the second conversion unit 113 illustrated in FIG. 1 may be realized by, for example, the CPU 410 executing the program stored in the RAM 420 or the flash memory 430 illustrated in FIG. 4. The processing of the output control unit 114 illustrated in FIG. 1 may be realized by, for example, the CPU 410 executing the program stored in the RAM 420 or the flash memory 430 illustrated in FIG. 4, or by the switch chip 440. The port 101 illustrated in FIG. 1 may be realized by, for example, the physical ports 451 to 454 illustrated in FIG. 4.

Example of Conversion Table According to Embodiment

FIG. 5 is a diagram illustrating an example of a conversion table according to the embodiment. As illustrated in FIG. 5, the conversion table T1 includes the respective fields of, for example, an input port number, an input VLAN-ID, an output port number, an output VLAN-ID, a temporary IP address, and a transmission source IP address. The conversion table T1 stores a record associated with information set (registered) in the respective fields of the conversion table T1.

In the conversion table T1, information indicating one of the physical ports 451 to 454 is set in each of the fields of the input port number and the output port number. For example, information indicating one of integers from “1” to “4” is set in each of the fields of the input port number and the output port number. “1” indicates the physical port 451, “2” indicates the physical port 452, “3” indicates the physical port 453, and “4” indicates the physical port 454.

In the conversion table T1, information indicating the VLAN-ID of the VLAN corresponding to each of the physical ports 451 to 454 is set in each of the fields of the input VLAN-ID and the output VLAN-ID. For example, information indicating one of integers from 1″ to “4094” is set in each of the fields of the input VLAN-ID and the output VLAN-ID. For example, in a case where information indicating “100” is set, it indicates that the VLAN-ID is “100”, and in a case where information indicating “200” is set, it indicates that the VLAN-ID is “200”.

The information set in each of the fields of the input VLAN-ID and the output VLAN-ID becomes 12 bit data that may represent the integers from “1” to “4094”, but the information is illustrated as a decimal value in FIG. 5.

In the conversion table T1, for example, a temporary IP address generated according to the generation rule which will be described below is set in a field of the temporary IP address.

Generation Rule of Temporary IP Address

A first octet of the temporary IP address is set to, for example, “224” which is used as a multicast address. A second octet of the temporary IP address is set to, for example, a decimal value of a higher order 4 bits of the input VLAN-ID (for example, data of 12 bits) stored in association with the temporary IP address. A third octet of the temporary IP address is set to, for example, an input port number stored in association with the temporary IP address. A fourth octet of the temporary IP address is set to, for example, an output port number stored in association with the temporary IP address.

As an example of the temporary IP address generated according to the generation rule, the temporary IP address generated for the records of the input port number “1”, the input VLAN-ID “100”, and the output port number “2” is “224.12.1.2”.

By generating the temporary IP address according to the generation rule, the transmission device 100 may generate the temporary IP address satisfying a format of the IP address (for example, a multicast address) through simple processing.

For example, the transmission device 100 may sequentially change values of the second octet, the third octet, or the fourth octet from “1” each time the temporary IP address is generated. The transmission device 100 may generate the temporary IP address in which, for example, the values of the second octet, the third octet, or the fourth octet are randomly determined from “0” to “255”. The generation rule of the temporary IP address may be randomly determined by a manufacturer or the like of the transmission device 100.

In the conversion table T1, information indicating a previously set IP address corresponding to a physical port indicated by an input port number is set in the field of a transmission source IP address. For example, in a case of the record having the input port number of “1”, information indicating an IP address “192.168.1.1” previously set corresponding to the physical port 451 is set in the field of the transmission source IP address.

Example of Distribution Table According to Embodiment

FIG. 6 is a diagram illustrating an example of a distribution table according to the embodiment. As illustrated in FIG. 6, the distribution table T2 includes the respective fields of a multicast address, an output VLAN-ID, and an output port number. The distribution table T2 stores records associated with information set (registered) in each field of distribution table T2.

In the distribution table T2, a multicast address indicating a destination of a multicast packet is set in the field of the multicast address. For example, the same IP address as the IP address set in the field of the temporary IP address in the conversion table T1 is set in the field of the multicast address.

In the distribution table T2, information indicating the VLAN-ID of the VLAN corresponding to the output port number stored in association with the output VLAN-ID is set in the field of the output VLAN-ID. For example, information indicating one of integers from “1” to “4094” is set in the field of the output VLAN-ID. For example, in a case where information indicating “200” is set, it indicates that the VLAN-ID is “200”.

In the distribution table T2, information specifying one of the physical ports 451 to 454 is set in the field of the output port number. For example, information indicating one of integers from “1” to “4” is set in the field of the output port number. “1” indicates the physical port 451, “2” indicates the physical port 452, “3” indicates the physical port 453, and “4” indicates the physical port 454.

Example of Operation of Transmission Device According to Embodiment

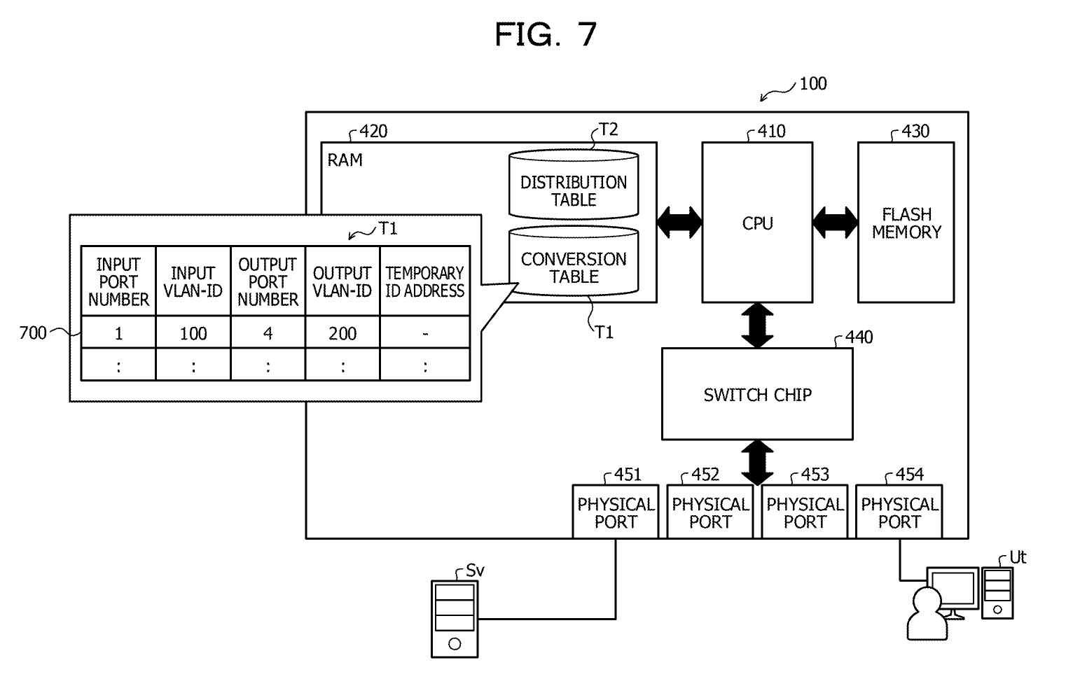

FIGS. 7 to 13 are diagrams (part 1) to (part 7) illustrating examples of operations of the transmission device according to the embodiment. In FIGS. 7 to 13, the same portions as those in FIG. 4 are denoted by the same reference numerals or symbols, and description thereof will be omitted.

In the examples illustrated in FIGS. 7 to 13, it is assumed that a multicast server Sv is connected to the physical port 451 of the transmission device 100 and a user terminal Ut is connected to the physical port 454 of the transmission device 100, as illustrated in FIG. 7 and the like. The examples illustrated in FIGS. 7 to 13 are examples in which the transmission device 100 transmits a multicast frame received from the multicast server Sv to the user terminal Ut. The multicast frame is, for example, an OAM frame.

As illustrated in FIG. 7, the CPU 410 first registers the input port number, the output port number, the input VLAN-ID, and the output VLAN-ID in the conversion table T1 in the RAM 420. In a case of the example illustrated in FIG. 7, the CPU 410 registers a record 700 indicating that, for example, the input port number is “1”, the input VLAN-ID is “100”, the output port number is “4”, and the output VLAN-ID is “200”, in the conversion table T1.

Although not illustrated in FIG. 7, at this time, the CPU 410 may also register a transmission source IP address in the conversion table T1 in association with the input port number and the like. The transmission source IP address of the record 700 is, for example, “192.168.1.1” previously set corresponding to the physical port 451.

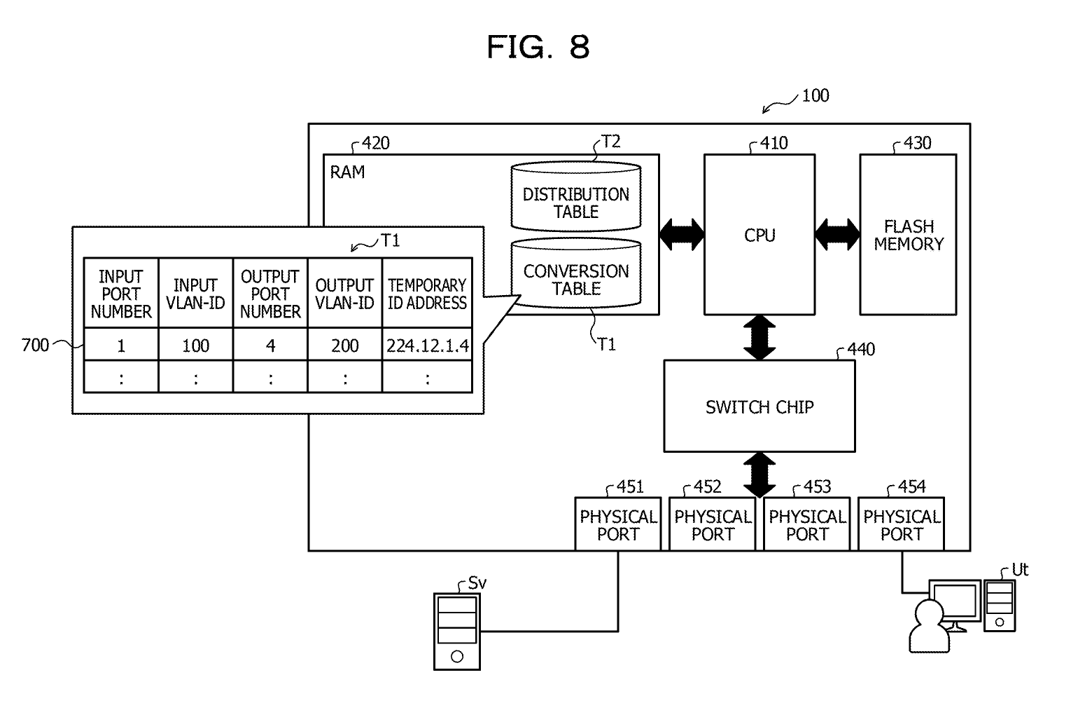

Next, as illustrated in FIG. 8, the CPU 410 generates a temporary IP address of the record 700 and registers the generated temporary IP address in the conversion table T1. For example, the CPU 410 generates the temporary IP address of the record 700 according to the generation rule described above. Thereby, the temporary IP address of the record 700 becomes “224.12.1.4”.

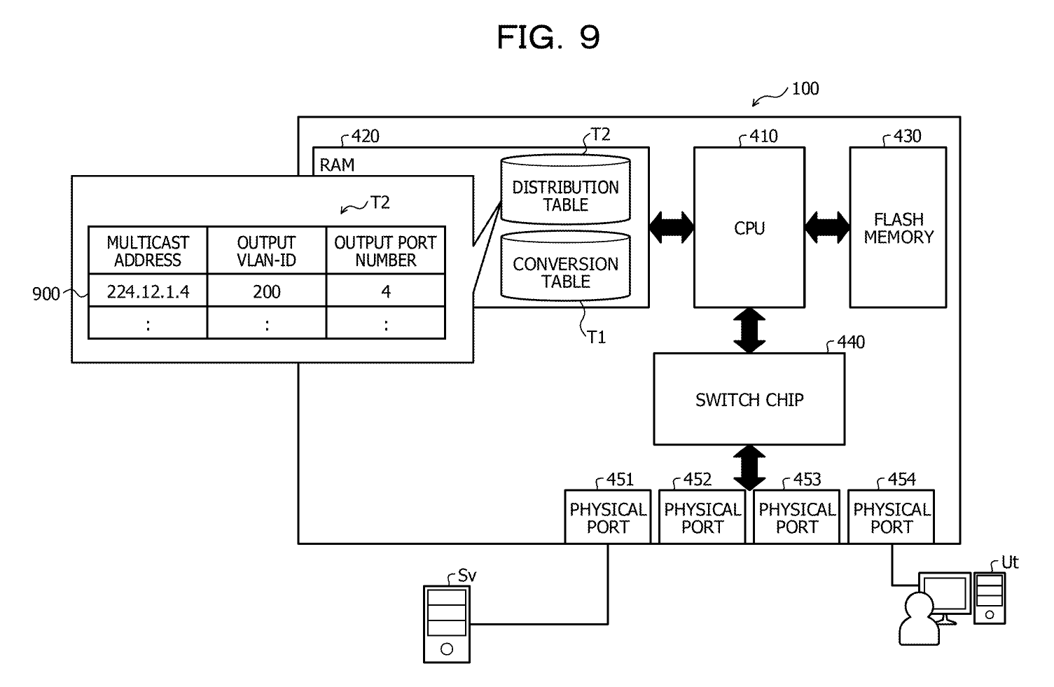

Next, as illustrated in FIG. 9, the CPU 410 registers a record 900 corresponding to the record 700 registered in the conversion table T1 in the distribution table T2. The record 900 indicates that the multicast address of a destination is “224.12.1.4”, the output VLAN-ID is “200”, and the output port number is “4”. For example, the multicast address of the destination of the record 900 is the temporary IP address of the record 700. The output VLAN-ID of the record 900 is the output VLAN-ID of the record 700. The output port number of the record 900 is the output port number of the record 700.

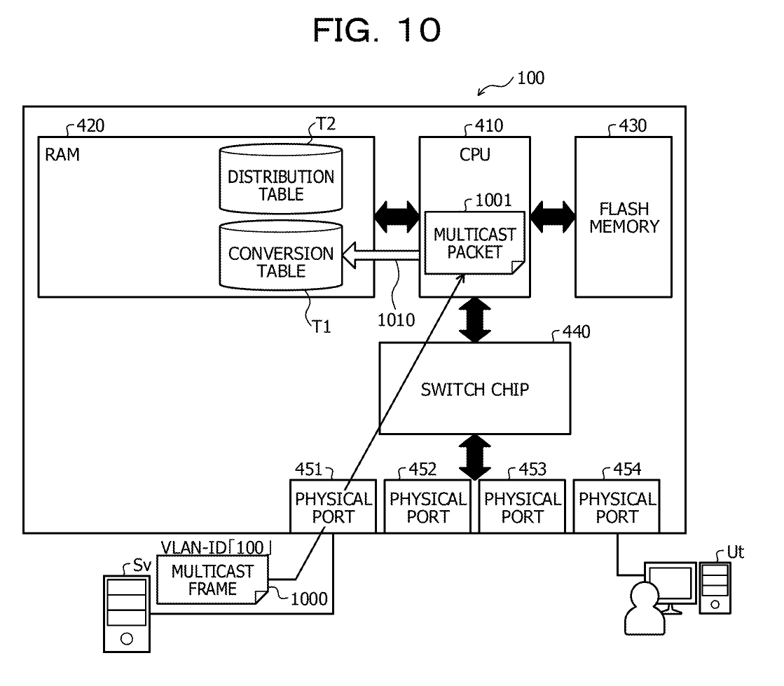

Thereafter, as illustrated in FIG. 10, it is assumed that the transmission device 100 receives a multicast frame 1000 from the multicast server Sv. For example, as illustrated in FIG. 10, it is assumed that a VLAN tag indicating the VLAN-ID “100” is added to the multicast frame 1000.

In this case, the CPU 410 determines whether or not the received data is a multicast frame. For example, in a case where there is no IP header in the received data, the transmission device 100 determines that the data is the multicast frame. In a case where it is determined that the received data is the multicast frame, the CPU 410 converts the received multicast frame 1000 into a multicast packet 1001 with reference to the conversion table T1 as indicated by an arrow 1010.

In a case of the example illustrated in FIG. 10, the CPU 410 refers to the record 700 corresponding to the input port number “1” and the input VLAN-ID “100” in the conversion table T1. The CPU 410 then adds an IP header having the temporary IP address indicated by the record 700 as the destination IP address and having the IP address of the physical port 451 to which the multicast frame 1000 is input as the transmission source IP address. Thereby, the CPU 410 converts the multicast frame 1000 into the multicast packet 1001.

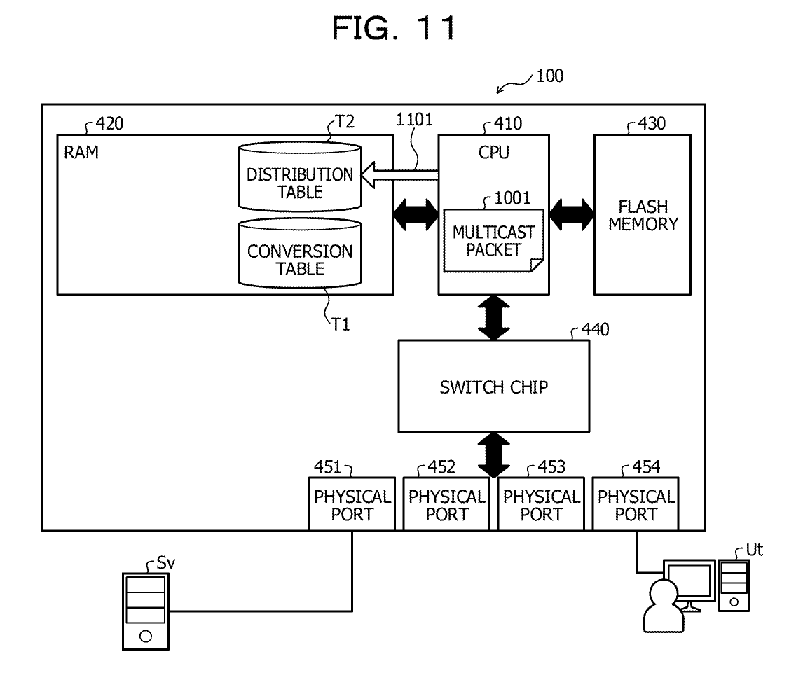

Next, as indicated by an arrow 1101 in FIG. 11, the CPU 410 specifies an output VLAN-ID and an output port number corresponding to the multicast packet 1001 with reference to the distribution table T2. In a case of the example illustrated in FIG. 11, the destination IP address indicated by the IP header of the multicast packet 1001 is “224.12.1.4”. Accordingly, the CPU 410 refers to the record 900 corresponding to “224.12.1.4” in the distribution table T2. Thereby, the output VLAN-ID and the output port number corresponding to the multicast packet 1001 are specified as the output VLAN-ID “200” and the output port number “4”, respectively. As such, by converting the input multicast frame 1000 into the multicast packet 1001, it is possible to specify the output VLAN-ID and the output port number based on the distribution table T2.

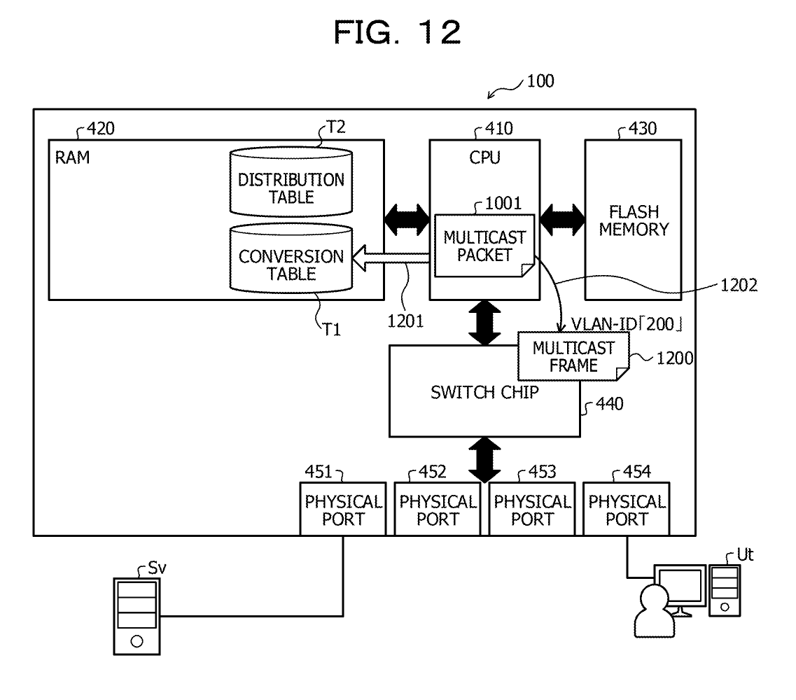

Next, as illustrated in FIG. 12, the CPU 410 removes the IP header from the multicast packet 1001 to convert into a multicast frame 1200. When converting into the multicast frame 1200, the CPU 410 may add a new VLAN tag indicating the VLAN-ID specified as an output destination of the multicast packet 1001. In a case of the example illustrated in FIG. 12, the CPU 410 converts the multicast packet into the multicast frame 1200 by adding the VLAN tag indicating the VLAN-ID “200”.

As indicated by an arrow 1201 in FIG. 12, the CPU 410 may refer to the conversion table T1 when performing a conversion into the multicast frame 1200. In a case of the example illustrated in FIG. 12, the CPU 410 may refer to the record 700 of the conversion table T1 used for a conversion into the multicast packet 1001. The CPU 410 may perform a conversion into the multicast frame 1200 by adding a VLAN tag indicating the output VLAN-ID “200” of the record 700.

After conversion into the multicast frame 1200 is performed, the CPU 410 outputs the multicast frame 1200 to the switch chip 440 as indicated by an arrow 1202. At this time, the CPU 410 instructs the switch chip 440 to output the multicast frame 1200 using the output VLAN-ID and the output port number which are specified for the multicast packet 1001.

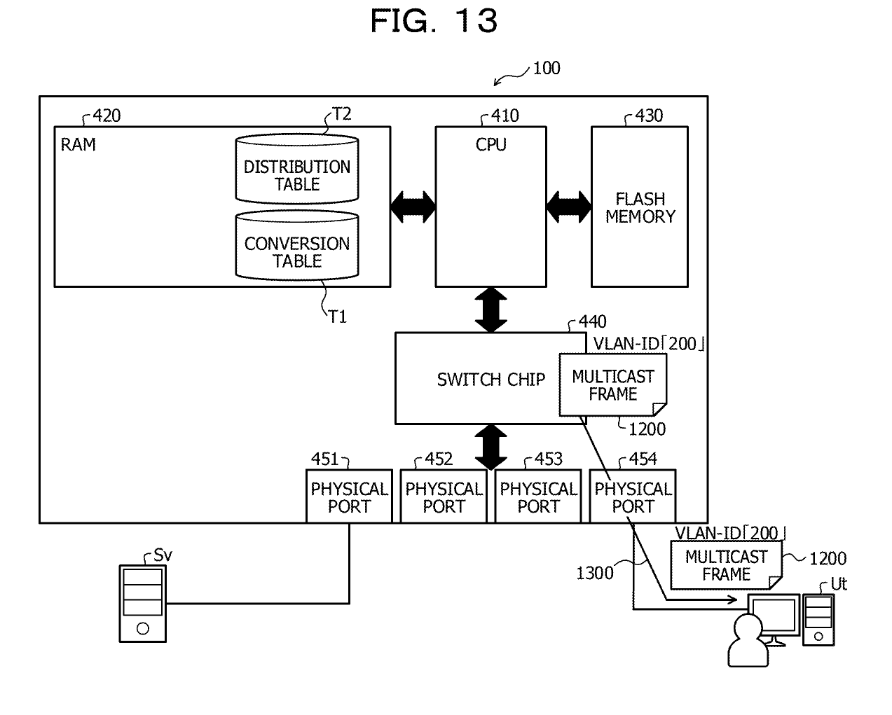

Accordingly, the switch chip 440 outputs the multicast frame 1200 from the physical port 454 as indicated by an arrow 1300 in FIG. 13. Thereby, the multicast frame 1200 is transmitted to the user terminal Ut connected to the physical port 454 and belonging to the VLAN with the VLAN-ID “200”.

Another Example of Processing Performed by Transmission Device According to Embodiment

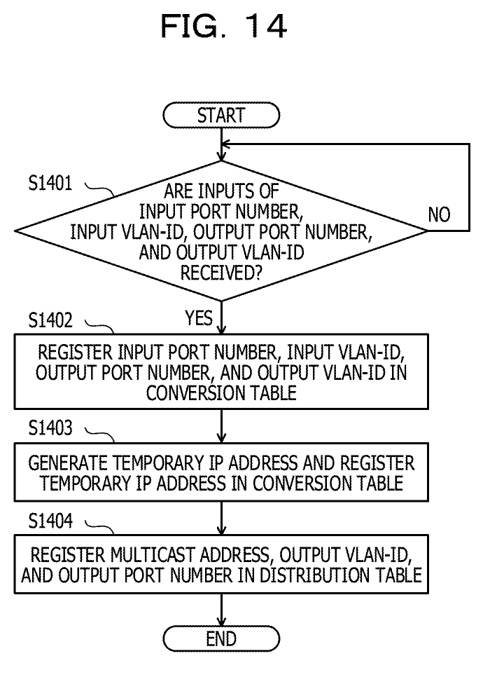

Next, another example of processing performed by the transmission device 100 will be described. FIG. 14 is a flowchart illustrating an example of registration processing performed by the transmission device according to the embodiment. FIG. 14 illustrates an example of a processing performed until the transmission device 100 registers a multicast address and the like in the distribution table T2.

As illustrated in FIG. 14, the transmission device 100 first determines whether or not inputs of an input port number, an input VLAN-ID, an output port number, and an output VLAN-ID are received (step S1401). In a case where it is determined that the inputs are not received (step S1401: No), the transmission device 100 repeats the processing of step S1401.

In a case where it is determined that the inputs are received (step S1401: Yes), the transmission device 100 registers the input port number, the input VLAN-ID, the output port number, and the output VLAN-ID which are received in the conversion table T1 (step S1402). As described above, the transmission device 100 may also register the IP address that is previously set corresponding to the physical port of the received input port number in the conversion table T1.

The transmission device 100 generates a temporary IP address according to the content registered in the conversion table T1 and the generation rule described above in step S1402 and registers the generated temporary IP address in the conversion table T1 (step S1403).

The transmission device 100 registers the multicast address, the output VLAN-ID, and the output port number in association with each other in the distribution table T2 (step S1404), and ends the processing illustrated in FIG. 14. In step S1404, the transmission device 100 registers the temporary IP address generated in step S1403 in the distribution table T2 as a destination multicast address. In step S1404, the transmission device 100 registers the output VLAN-ID and the output port number which are the same as the output VLAN-ID and the output port number registered in the conversion table T1 in step S1402, in the distribution table T2.

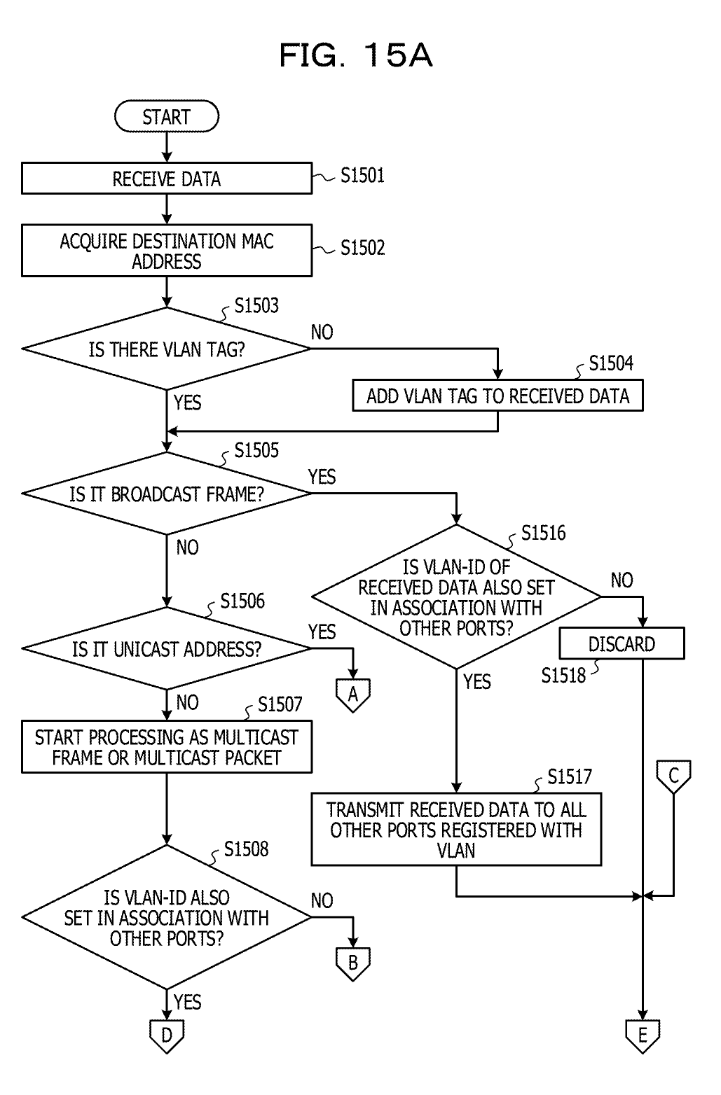

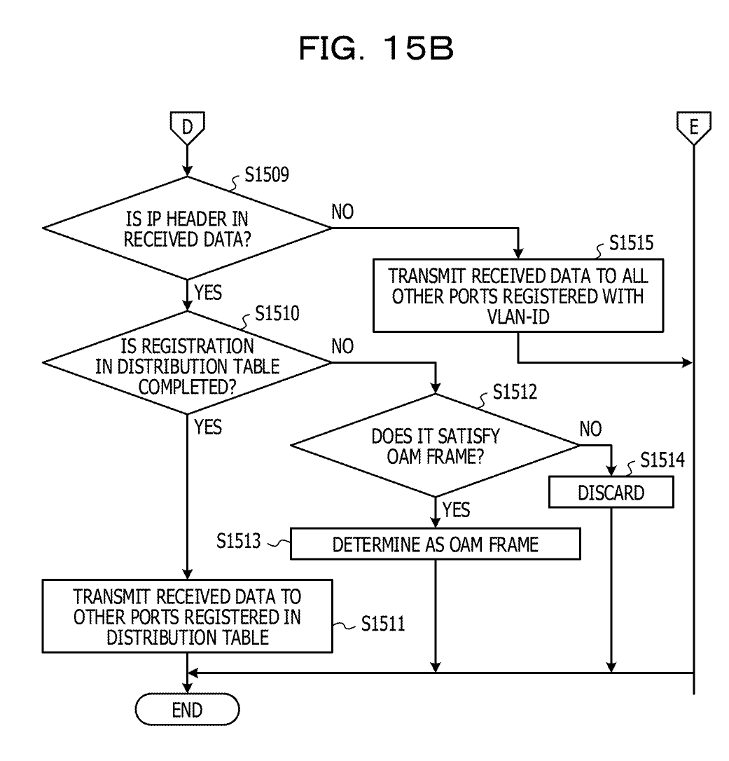

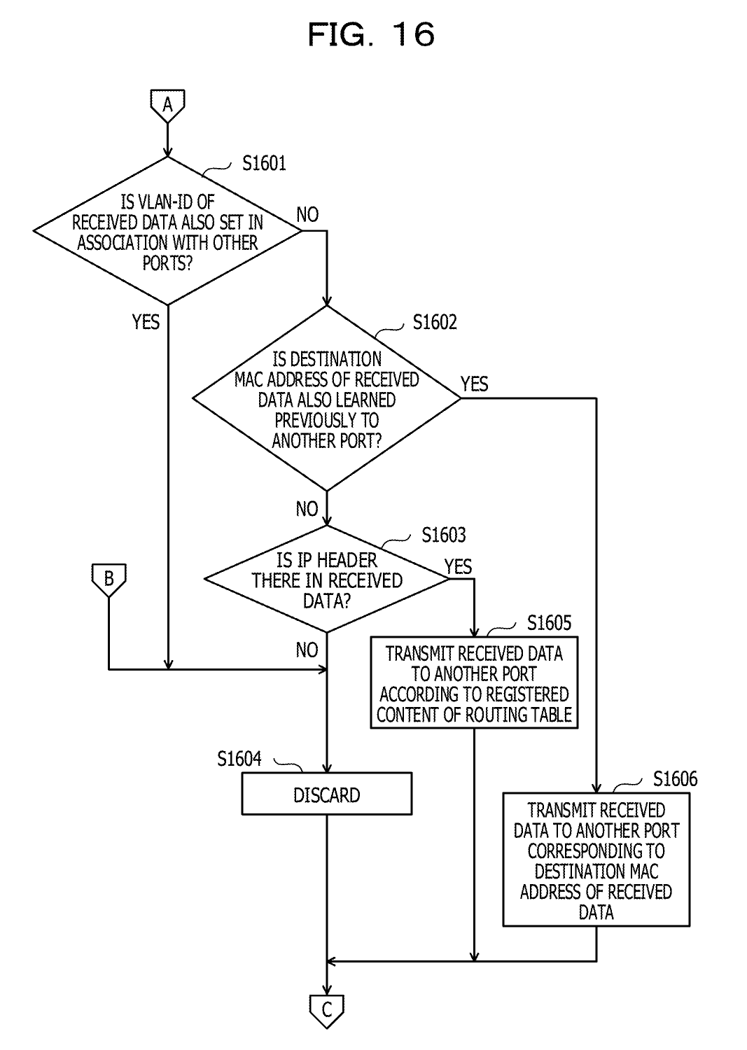

FIG. 15 is a flowchart (part 1) illustrating an example of transmission processing performed by the transmission device according to the embodiment. FIG. 16 is a flowchart (part 2) illustrating an example of the transmission processing performed by the transmission device according to the embodiment. For example, as data is input to any of the physical ports 451 to 454, the transmission device 100 may perform the processing illustrated in FIGS. 15 and 16.

As illustrated in FIG. 15, the transmission device 100 first receives data input to one of the physical ports 451 to 454 (step S1501). Hereinafter, in the descriptions of FIG. 15 and FIG. 16, the data received in step S1501 is simply referred to as “received data”. Hereinafter, in the descriptions of FIGS. 15 and 16, the physical port to which the received data is input among the physical ports 451 to 454 is referred to as an “input port”, and the physical ports other than the input port among the physical ports 451 to 454 are referred to as “other ports”.

Next, the transmission device 100 acquires a destination MAC address corresponding to a destination address of a data link layer of the received data with reference to a MAC header of the received data (step S1502). The transmission device 100 determines whether or not a VLAN tag is added to the received data (step S1503). In a case where it is determined that the VLAN tag is added to the received data (step S1503: Yes), the transmission device 100 proceeds to the processing of step S1505.

In a case where it is determined that the VLAN tag is not added to the received data (step S1503: No), the transmission device 100 adds the VLAN tag to the received data (step S1504) and proceeds to the processing of step S1505. In step S1504, for example, the transmission device 100 adds a VLAN tag indicating a VLAN-ID (for example, a default VLAN-ID) previously set to the input port to the received data.

Next, the transmission device 100 determines whether or not the received data is a broadcast frame (step S1505). In step S1505, for example, the transmission device 100 determines that the received data is a broadcast frame on condition that the MAC address of the received data is a MAC address for the broadcast frame. An example of the MAC address for the broadcast frame is “FF:FF:FF:FF:FF:FF”.

In a case where it is determined that the received data is not the broadcast frame (step S1505: No), the transmission device 100 determines whether or not the destination MAC address of the received data acquired in step S1502 is a unicast address (step S1506). In step S1506, for example, the transmission device 100 determines that the received data is the unicast address on condition that a value of an JIG bit of the received data is “0”. The JIG bit is, for example, the least significant bit of a first octet of the MAC address.

In a case where it is determined that the received data is not the unicast address (step S1506: No), the transmission device 100 starts processing the received data as a multicast frame or a multicast packet (step S1507). The transmission device 100 determines whether or not the VLAN-ID of the received data is also set in association with the other ports (step S1508).

In step S1508, for example, the transmission device 100 acquires the VLAN-ID corresponding to each other port with reference to information indicating the VLAN-ID corresponding to each of the physical ports 451 to 454 previously stored. Next, the transmission device 100 determines whether or not there is a VLAN-ID that matches the VLAN-ID of the received data among the VLAN-IDs corresponding to each of the other ports. The transmission device 100 makes a positive determination in step S1508, on condition that there is a VLAN-ID that matches the VLAN-ID of the received data among the VLAN-IDs corresponding to each of the other ports.

In step S1508, for example, the transmission device 100 may determine whether or not an output VLAN-ID corresponding to a combination of an input port and the VLAN-ID of the received data is set with reference to the conversion table T1. For example, it is assumed that the input port is the physical port 451 and the VLAN-ID of the received data is “100”. In this case, the transmission device 100 determines whether or not the output VLAN-ID is registered for a combination of the input port number “1” and the input VLAN-ID “100” in the conversion table T1. Then, the transmission device 100 may make a positive determination in step S1508 on condition that it is determined that the output VLAN-ID is registered.

In a case where it is determined that a negative determination is made in step S1508 (step S1508: No), the transmission device 100 proceeds to processing in step S1604 which will be described below. In a case where it is determined that a positive determination is made in step S1508 (step S1508: Yes), the transmission device 100 determines whether or not there is an IP header in the received data (step S1509).

In a case where it is determined that there is the IP header in the received data (step S1509: Yes), the transmission device 100 determines whether or not a destination IP address indicated by the IP header of the received data is registered in the distribution table T2 (step S1510). In a case where it is determined that registration is completed (step S1510: Yes), the transmission device 100 transmits the received data to another port according to the registration in the distribution table T2 corresponding to the destination IP address indicated by the IP header of the received data (step S1511). Then, the transmission device 100 ends the processing illustrated in FIG. 15.

Although not illustrated in FIG. 15, before the received data is transmitted to another port in step S1511, the transmission device 100 may perform the processing illustrated in steps S205 to S207 in FIG. 2 and may transmit the data obtained in the processing to another port.

In a case where it is determined that registration is not completed in step S1510 (step S1510: No), the transmission device 100 determines whether or not the received data satisfies the condition of the OAM frame (step S1512). In step S1512, for example, the transmission device 100 determines that the condition of the OAM frame is satisfied on condition that a Type value of the received data is “0×8901” and a destination MAC address of the received data is a predetermined MAC address. For example, the predetermined MAC address is any one of the MAC addresses included in a range from “01:80:c2:00:00:30” to “01:80:c2:00:00:3r.

In a case where it is determined that the received data satisfies the condition of the OAM frame in step S1512 (step S1512: Yes), the transmission device 100 determines that the received data is the OAM frame (step S1513) and ends the processing illustrated in FIG. 15. Although not illustrated in FIG. 15, the transmission device 100 may perform the processing illustrated in steps S205 to S207 and the like in FIG. 2 on condition that it is determined as the OAM frame in step S1513, and may transmit the data obtained in the processing to another port. In this case, the transmission device 100 may also transmit information for instructing that the above-described registration request is transmitted, to the operation terminal 331. In a case where the registration request is received from the operation terminal 331, the transmission device 100 may perform the processing illustrated in steps S201 to S203, S210, and the like in FIG. 2. Thereafter, the transmission device 100 may perform the processing illustrated in steps S205 to S207 and the like in FIG. 2 and transmit the data obtained in the processing to another port.

In a case where it is determined that the received data does not satisfy the OAM frame condition in step S1512 (step S1512: No), the transmission device 100 discards the received data (step S1514) and ends the processing illustrated in FIG. 15. In a case where it is determined that there is no IP header in the received data (step S1509: No), the transmission device 100 transmits the received data to all the other ports registered with the VLAN-ID of the received data (step S1515) and ends the processing illustrated in FIG. 15.

In a case where it is determined that the received data is a broadcast frame in step S1505 (step S1505: Yes), the transmission device 100 proceeds to processing in step S1516. For example, in the same manner as in step S1508, the transmission device 100 determines whether or not the VLAN-ID of the received data is also set in association with another port (step S1516).

In a case where a positive determination is made in step S1516 (step S1516: Yes), the transmission device 100 transmits the received data to all the other ports corresponding to the VLAN-ID of the received data (step S1517) and ends the processing illustrated in FIG. 15. In a case where a negative determination is made in step S1516 (step S1516: No), the transmission device 100 discards the received data (step S1518) and ends the processing illustrated in FIG. 15.

In a case where it is determined that the received data is a unicast address in step S1506 (step S1506: Yes), the transmission device 100 proceeds to the processing in step S1601 illustrated in FIG. 16. For example, in the same manner as in step S1508, the transmission device 100 determines whether or not the VLAN-ID of the received data is also set in association with another port (step S1601).

In a case where a positive determination is made in step S1601 (step S1601: Yes), the transmission device 100 proceeds to processing in step S1604. In a case where a negative determination is made in step S1601 (step S1601: NO), the transmission device 100 determines whether or not a destination MAC address of the received data is previously learned in another port (step S1602). In step S1602, for example, the transmission device 100 may determine whether or not the destination MAC address of the received data is previously learned with reference to a MAC learning table stored in the RAM 420.

In a case where a negative determination is made in step S1602 (step S1602: No), the transmission device 100 determines whether or not there is an IP header in the received data (step S1603). In a case where it is determined that there is no IP header in step S1603 (step S1603: No), the transmission device 100 discards the received data (step S1604), and ends the processing illustrated in FIG. 16.

For example, in a case where it is determined that there is an IP header (step S1603: Yes), the transmission device 100 transmits the received data to another port according to the registered content of the routing table corresponding to the destination IP address of the IP header of the received data (step S1605). Then the transmission device 100 ends the processing illustrated in FIG. 16. In step S1605, for example, the transmission device 100 specify the physical port to be transmitted with reference to the routing table stored in the RAM 420, and transmits the received data to the specified physical port.

In a case where a positive determination is made in step S1602 (step S1602: Yes), the transmission device 100 transmits the received data to another port corresponding to the destination MAC address of the received data (step S1606). Then, the transmission device 100 ends the processing illustrated in FIG. 16. In step S1606, for example, the transmission device 100 specifies the physical port to be transmitted with reference to the MAC learning table stored in the RAM 420, and transmits the received data to the specified physical port.

Example of Transmission of OAM Frame in Carrier Network Installed with Transmission Device According to Embodiment

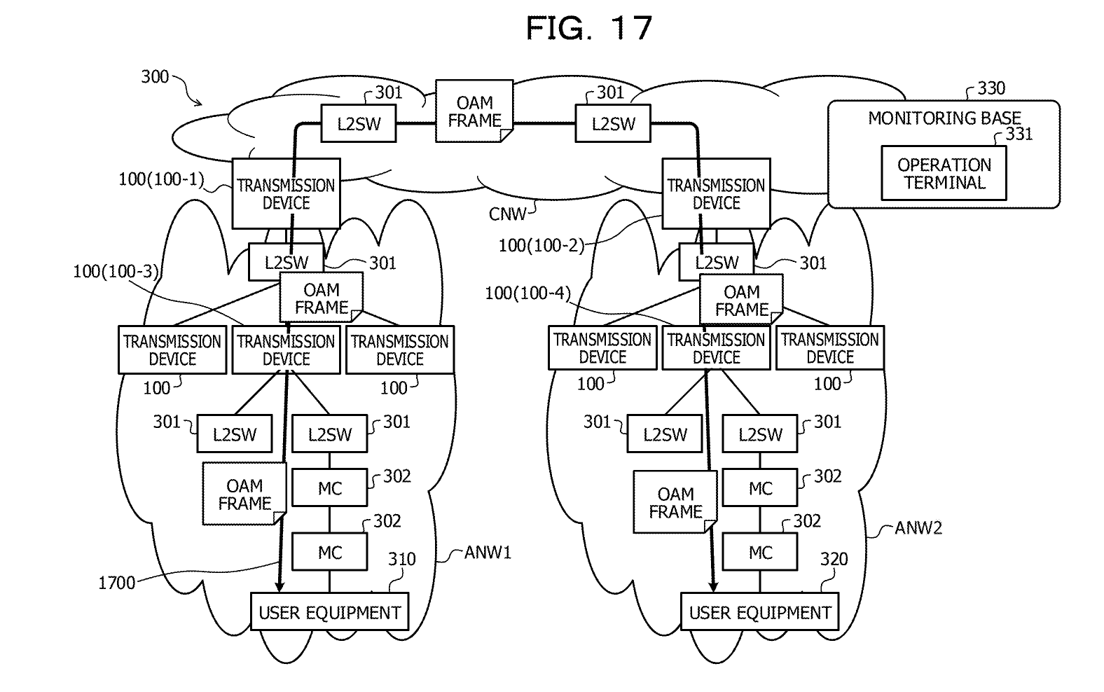

Next, an example of transmission of an OAM frame in the carrier network 300 installed with the transmission device 100 will be described. FIG. 17 is a diagram illustrating an example of transmission of an OAM frame in a carrier network installed with the transmission device according to the embodiment. In FIG. 17, the same portions as those in FIG. 3 are denoted by the same reference numerals or symbols, and description thereof will be omitted.

As described above, each transmission device 100 installed in the carrier network 300 may transmit an input frame as a frame instead of a packet. Accordingly, for example, the transmission device 100-3 may transmit the OAM frame transmitted from the user equipment 310 to the transmission device 100-1. The transmission device 100-1 may transmit the OAM frame transmitted by the transmission device 100-3 to the transmission device 100-2. The transmission device 100-2 may transmit the OAM frame transmitted by the transmission device 100-1 to the transmission device 100-4. The transmission device 100-4 may transmit the OAM frame transmitted by the transmission device 100-2 to the user equipment 320.

Likewise, for example, the transmission device 100-4 may transmit the OAM frame transmitted from the user equipment 320 to the transmission device 100-2. The transmission device 100-2 may transmit the OAM frame transmitted by the transmission device 100-4 to the transmission device 100-1. In addition, the transmission device 100-1 may transmit the OAM frame transmitted by the transmission device 100-2 to the transmission device 100-3. The transmission device 100-3 may transmit the OAM frame transmitted by the transmission device 100-1 to the user equipment 310.

Thus, in the carrier network 300, the OAM frame may be transmitted from the user equipment 310 to the user equipment 320 or from the user equipment 320 to the user equipment 310, as indicated by an arrow 1700 in FIG. 17.

As described above, according to the transmission device 100 of the embodiment, a frame not including a destination address of a network layer input to any port is converted into a packet including the destination address of the network layer. Then the transmission device 100 specifies a port corresponding to the destination address of the network layer of the converted packet. Then, the transmission device 100 converts the converted packet into a frame not including the destination address of the network layer, and outputs the converted frame from the specified port. Thereby, the transmission device 100 may transmit the frame not including the input destination of the network layer as a frame instead of a packet. Thus, according to the transmission device 100, it is possible to perform a frame transmission between apparatuses that perform processing of a data link layer via the transmission device 100.

The transmission device 100 may convert the input frame into a packet in a case where the input frame is a frame of a specific type. In this case, the transmission device 100 may not convert the input frame into the packet in a case where the input frame is a frame of a type other than the specific type. Thereby, the transmission device 100 may transmit only the frame of the specific type among the input frames. Thus, the transmission device 100 may reduce a processing load of the transmission device 100, as compared with a case where the frame of the type other than the specific type among the input frames is also transmitted. The transmission device 100 may reduce traffic of a transmission destination network generated by the transmission device 100, as compared with a case where the frame of the type other than the specific type among the input frames is also transmitted.

The transmission device 100 may convert the frame input only in a case where the input frame is an OAM frame into a packet. Thereby, the transmission device 100 may transmit only the OAM frame demanded for using a function of the Ethernet OAM, among the input frames.

The transmission device 100 may convert the converted packet into a frame including identification information for identifying the VLAN corresponding to the specified port. Thereby, even in a case where the VLAN to which an apparatus that performs processing of a data link layer of a transmission destination by using the transmission device 100 belongs is different from a VLAN to which an apparatus that performs processing of a data link layer that inputs a frame to the transmission device 100 belongs, the transmission device 100 may perform a frame transmission.

The transmission device 100 may receive input/output port information and generate a destination address of a network layer in association with the received input/output port information. In a case where a frame is input to an input port indicated by the received input/output port information, the transmission device 100 adds a header storing the generated destination address of the network layer to the input frame, thereby, converting the input frame into a packet. The transmission device 100 may specify a port corresponding to the destination address of the network layer of the converted packet with reference to the input/output port information associated with the destination address of the network layer stored in the header of the converted packet. Thereby, the transmission device 100 may transmit a frame of content, based on the received input/output port information. Accordingly, even if an operator does not determine an IP address or the like to be added to the transmission device 100 by itself, the operator transmit the input/output port information to the transmission device 100, thereby, being able to transmit a frame to the transmission device 100, based on the input/output port information.

For example, in the related art, for the purpose of steadily confirming an operational state at a data link layer level (for example, a layer 2 level) of a vast network such as a carrier network, Ethernet OAM CF CFM is used. According to the Ethernet OAM CFM, it is possible to utilize for isolating a failure factor and the like since confirmation or the like of a communication state at the data link layer level is performed in which a terminal not having an IP address such as L2SW or MC is also included.

However, the OAM frame used for the Ethernet OAM is, for example, a multicast frame, thereby, becoming data according to the data link layer protocol. Accordingly, in the related art, in a router or the like connecting the data link layer to a network layer, the OAM frame received from the data link layer side may not be transmitted to the network layer side.

Accordingly, end-to-end communication confirmation via a network of the network layer is demanded to use Ping which is a test method for an IP packet in which so-called “router exceeding” is possible. However, since the Ping is the communication confirmation between two bases having the IP addresses, it is not possible to perform a Ping test towards L2SW or MC that do not include the IP address. Thus, in the Ping, it is not possible to perform the communication confirm for L2SW or MC that do not include the IP address.

Under the circumstances, it is desirable to operate with an Ethernet OAM that may normally confirm a communication at the data link layer level, even for a terminal that does not have an IP address from a layer 2 VPN service provider. However, as described above, since the OAM frame is a multicast frame, the router exceeding may not be made in the related art. Accordingly, in the related art, if the Ethernet OAM is intended to be used, not only the Ethernet OAM is managed after being shredded between the respective layer 2 sections and the management is cumbersome, but also it is possible to simply confirm an end-end communication.

It is also conceivable to realize beyond the router exceeding by encapsulating and packetizing a frame. However, if an OAM frame is packetized and transmitted, the OAM frame is encapsulated, and thus, even if a layer 2 switch or the like is received, it is not possible to identify the layer 2 switch from the OAM frame. For example, even if the layer 2 switch receives a packet obtained by encapsulating the OAM frame, it is not possible to use functions such as CC, LB, and LT by the Ethernet OAM for the layer 2 switch. Accordingly, it is not possible to isolate the cause when a failure occurs, by using the functions such as CC, LB, and LT by the Ethernet OAM.

In contrast to this, according to the transmission device 100 of the embodiment, it is possible to transmit an input OAM frame as a frame instead of a packet (for example, the router exceeding is made). Hence, according to the transmission device 100, for example, as illustrated in FIG. 17, it is possible to realize an end-end transmission (for example, transmission of an OAM frame from the user equipment 310 to the user equipment 320) of the OAM frame.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A transmission device comprising:
a plurality of ports;
a first conversion circuit that converts a frame that is input to any one of the plurality of ports and does not include a destination address of a network layer into a packet including the destination address of the network layer;
a specification circuit that specifies a port corresponding to the destination address of the network layer of the packet that is converted by the first conversion circuit among the plurality of ports;
a second conversion circuit that converts the packet into the frame that does not include the destination address of the network layer; and
an output control circuit that causes the frame that is converted by the second conversion circuit to be output from the port that is specified by the specification circuit.

2. The transmission device according to claim 1,
wherein the first conversion circuit converts the frame of a specific type that is input to any one of the plurality of ports into the packet and does not convert the frame of a type other than the specific type that is input to any one of the plurality of ports into the packet.

3. The transmission device according to claim 2,
wherein the frame of the specific type is an OAM frame.

4. The transmission device according to claim 1,
wherein the first conversion circuit converts the input frame into the packet by adding a header storing the destination address of the network layer to the input frame.

5. The transmission device according to claim 4,
wherein the second conversion circuit converts the packet into the frame by removing the header that is added by the first conversion circuit from the packet.

6. The transmission device according to claim 1,
wherein the second conversion circuit converts the packet into the frame including identification information for identifying a VLAN corresponding to the port that is specified by the specification circuit.

7. The transmission device according to claim 1,
wherein the first conversion circuit receives input/output port information indicating a port to which the frame is input among the plurality of ports and a port from which the frame output among the plurality of ports, generates the destination address of the network layer in association with the input/output port information that is received, and converts the input frame into the packet by adding a header storing the generated destination address of the network layer to the input frame in a case where the frame is input to the input port which is indicated by the input/output port information that is received, and
wherein the specification circuit specifies the port corresponding to the destination address of the network layer of the packet with reference to the input/output port information that is associated with the destination address of the network layer which is stored in the header of the packet that is converted by the first conversion circuit.

8. A transmission method that is performed by a transmission device including a plurality of port, the method comprising:
converting a frame that is input to any one of the plurality of ports and does not include a destination address of a network layer into a packet including the destination address of the network layer;
specifying a port corresponding to the destination address of the network layer of the converted packet among the plurality of ports;
converting the packet into the frame that does not include the destination address of the network layer; and
outputting the converted frame from the specified port.
